(19) United States
(12) Patent Application Publication
(10) Pub. No.: US 2009/0300012 A1
(43) Pub. Date: Dec. 3, 2009

(54) MULTILEVEL INTENT ANALYSIS METHOD FOR EMAIL FILTRATION

(75) Inventors: Zachary Levow, Mountain View, CA (US); Dean Drako, Los Altos, CA (US)

Correspondence Address: BARRACUDA NETWORKS, INC;ATTENTION: PETER HWANG, 3175 S. WINCHESTER BOULEVARD, CAMPBELL, CA, 95008, US

(73) Assignee: BARRACUDA INC., Campbell, CA (US)

(21) Appl. No.: 12/128,286

(22) Filed: May 28, 2008

(51) Int. Cl. G06F 17/30; G06F 15/16

(52) U.S. Cl. 707/6; 707/10; 707/E17.032; 707/E17.014

(57) ABSTRACT

A method for filtering email which contains links to uniform resource identifiers which disguise the content and identity of spam sites by multiple serial redirection.

### BACKGROUND

| Term | Definition |
|---|---|
| spam | An unsolicited bulk email message |
| Redirection | A status code, text, or script that causes or invites a |
| directives | user or browser to go to another uri |
| Traversing | Following redirection as a browser would in |
| | executing a redirection or as user would by clicking |
| | on a link |
| Uri | Uniform resource identifier; actual standard name for |
| | what is commonly or historically called url. See |
| | Website address. |
| link | A reference or navigation element in a document to |
| | another document or resource, |
| | often uses a uri. |
| Website address | A website is a collection of Web pages, images, |
| | videos, documents or resources that is hosted on one |
| | or more web servers. Example of an address: |
| | Protocol://server.domain.tld/path/resource.file?script |
| | The format of a website address has a protocol which |
| | accesses a resource hosted on a domain. The name |
| | of the server may precede the domain or not. |
| | Characters following the server name and ending |
| | with a top-level domain name like .com, .net, .org, |
| | .gov, etc., or a country code (e.g., uk, au, ca) |
| | comprise the domain name. The path to the resource |
| | may follow the domain as well as a script or string for |
| | a database to use. Scanning a website address for a |
| | domain name is known to those skilled in the art. |
| Spam website | A website containing messages stored for display to |
| | recipients of bulk email. |
| Target website/uri | The website at the end of a chain of redirections. |
| | The terminal website. |
| Tidied website | A website whose management has deleted redirection |
| | pages created by spammers when notified and flags |
| | removal with identifiable text, a special page, or a |
| | status code |
| Matching | Identifying a text string of interest according to a |
| | regular expression which defines a pattern. |
| Grade value | A numerical or letter score, a flag, code, or symbol. |

Unsolicited bulk email messages commonly called spam are nearly free for the sender to send and they are being sent in large growing volumes. They are expensive to the receivers in wasted resources, fraud, and lost productivity.

Conventional methods provide for filtering spam either at the desktop or at a mail server. It is common knowledge to those skilled in the art to examine subject lines and message content for certain keywords to determine that an email is likely to be spam. As an example, words for male sexual enhancement products are generally reliable indicators of one type of spam. This conventional process is called content filtering.

To counteract the effectiveness of content filters, spammers have delivered specious messages which link to a website which delivers the messaging in text, images, or audio-visual presentation. Of course, those skilled in the art can incorporate the uniform resource identifier (uri) of the spam website into content or similar filters.

To avoid email content filters the embedded link may be changed quickly by automatically creating a large and dynamic number of new redirection websites whose purpose is to redirect the user to the spam website. These redirecting websites may be created and abandoned faster than conventional content filters can be updated to match them. It also becomes impractical to operate a content filter if the number of websites created that need to be filtered is large due to automation.

Sender Identity Obfuscation—Conventional source reputation techniques have been used to combat spammers by profiling the sender's history. This enables a spam filter to block spam efficiently by doing a simple database lookup on the source. Spammers have resorted to obfuscating their identities more systematically to avoid this. Sender identity obfuscation may result from spammers taking control of networks of computers infected with a form of malware to create a botnet. The spammer's control over other computers allow them to send email from diverse sources throughout the Internet. In doing so the spammer effectively hides his own identity from conventional source reputation checks that profile sender network addresses. Just as botnets have enabled spammers to send from many sender IP addresses, inexpensive domain registrations and free redirection sites have enabled spammers to create new domain identities quickly and inexpensively. By redirecting to spam websites through reputable blogs, free Web site providers, URL redirection services or other methods known to those skilled in the art, spammers have hidden their identity from conventional content filtering of messages which look for spam websites or uniform resource identifiers.

Referring now to FIG. 1 a block diagram illustrates a plurality of websites containing redirecting uniform resource identifiers (uri) 151-15n created by the spammer to disguise the location of the spam website 160. The emails 131-132 contain at least a link to the redirecting website which makes a conventional content filter ineffective at blocking spam because the embedded uri is changed quickly in subsequently transmitted email. The spammer is able to rapidly create new redirecting uri's so that new emails contain links to websites not known to be related to spam. Thus the spam website uri 160 is effectively hidden from conventional content filters operating only on the email itself. To appreciate the limitations of conventional analyzers, consider the illustration in FIG. 4. A database 410 contains text strings which the conventional analyzer 420 references in searching documents. In an embodiment, these strings may be a website or a uniform resource identifier. A string not found in the database results in “No Match”. However, in the example, NICE.COM turns out to link to a redirect document which in turn links to a known spam website, BAD.COM which is not discoverable by conventional filtering. Redirection defeats conventional content filtering.

Thus it can be appreciated that what is needed is a method for determining that an email is actually spam although the embedded uniform resource identifier within the email only references a redirecting resource which is not within a database of spam websites.

The present invention accesses uri's by following redirection directives and comparing uri's with a database of spam uri's. The best mode of the invention adds a number of optimizations to reduce the number of uri's that must be followed. In general the method has the steps of analyzing and grading documents such as email.

The objective of the invention is to set a grade value for a document such as email comprising one selected from the following: a numerical value, a letter, match, no-match, category, string, pass, and fail. The invention may itself operate on the document or simply mark it for another tool to operate on the document. These operations include but are not limited to causing the document to be blocked, deleted, diverted to a spam mailbox, marked with warning messages, sterilized, quarantined, or modified, depending on the grade value; else, passing it on to one of an addressee, a user agent, a mail server, a gateway, and another filter, or doing nothing to it.

The best mode embodiment is illustrated in FIG. 8 includes using a database to assist in the following steps:
selecting links,
following links, and
matching links.

Rather than selecting and analyzing all of the links that may be embedded in a document it is more efficient to maintain a “follow database” and only select links
which are hardcoded, or
match a follow database, for example domains, websites or strings that reference complimentary web hosts whereby anonymous users may freely publish content comprising at least one of scripts, hypertext documents, and redirection instructions.

Following links may also be optimized by consulting a database of what we define as tidied websites. Following links comprises the steps of
requesting a resource by using the protocol and hierarchical path of a uri as a user would by clicking or as a browser would in displaying a hypertext document;
receiving at least one of codes, scripts, content, and redirection instructions from the server; and
analyzing at least one of codes, scripts, content, and redirection instructions for additional uri's. Less analysis is needed where the link is found in a third category of database, herein defined to be tidied websites, containing special codes, special pages, and identifiable text whereby a tidied website manager indicates that requested content has been purposefully removed.

If we are not so fortunate to come upon a tidied website then we must
extract at least one domain name from the content or the redirection instruction and
match at least one domain name with one of a first category of websites in a database and if no match repeat until the final website is reached.

The first category of websites are herein defined as spam websites whereby messages are stored for display to recipients of unsolicited bulk email commonly referred to as spam.

### BRIEF DESCRIPTION OF FIGURES

FIG. 1 is a block diagram of a plurality of redirecting uniform resource identifiers separating an email recipient from the content stored at a spam website.

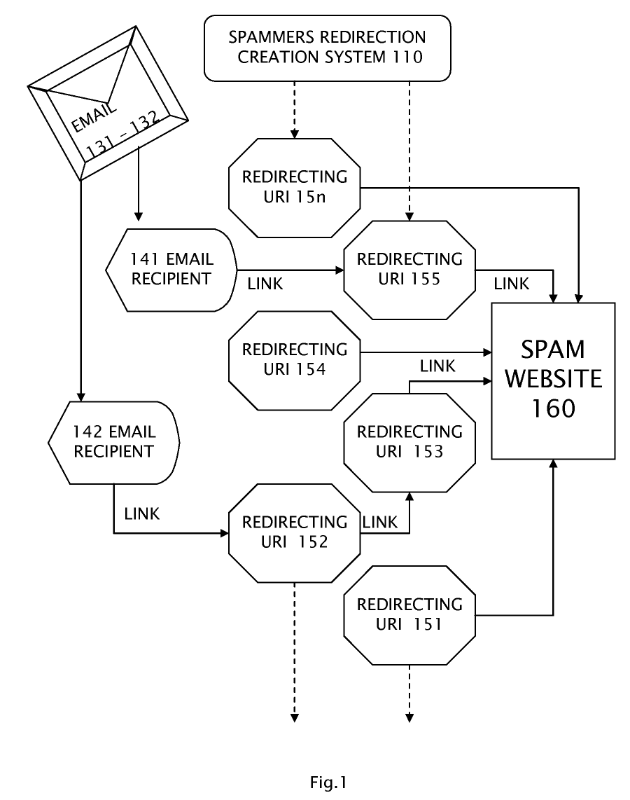

FIG. 2 is a flowchart of a method for storing a database of websites in a category.

FIG. 3 is a flowchart of a method for using a database of websites to filter spam.

FIG. 4 illustrates a problem of conventional analysis for content filtering.

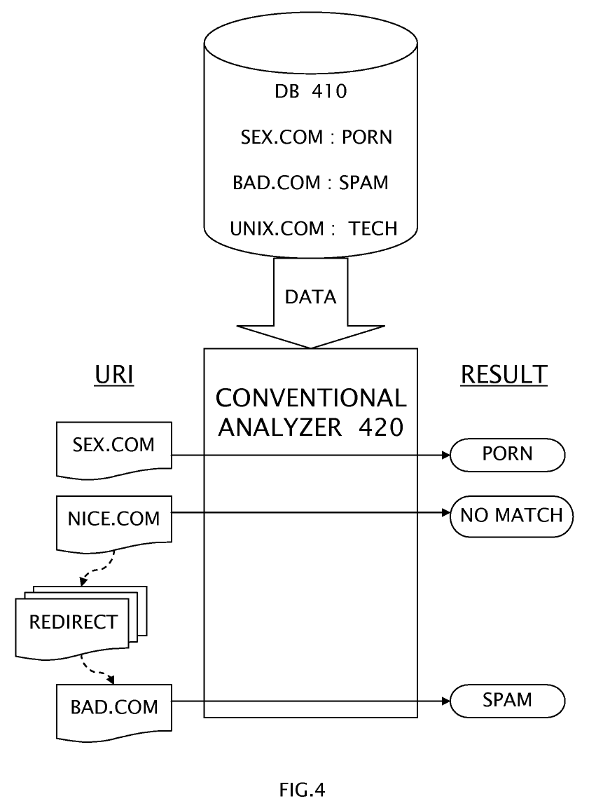

FIG. 5 is a block diagram of a computing system embodiment of the invention.

FIG. 6 is a block diagram illustrating the present invention.

FIG. 7 is a block diagram of an enhanced embodiment.

FIG. 8 is a block diagram of the best mode embodiment.

### DETAILED DISCLOSURE OF THE INVENTION

The present invention is a method comprising analyzing, and grading a document such as email. The process of grading means setting a grade value for a document which include but are not limited to a numerical value, a letter, match, no-match, category, string, pass, and fail.

The process further comprises operating on a document includes performing at least one of the following actions or causing one or more to be performed by another system:
blocking,
deleting,
diverting to a spam mailbox,
marking with warning messages,
sterilizing,
quarantining,
modifying,
tagging with a string,
notifying user of a category,
or
passing it on to one of an addressee, a user agent, a mail server, a gateway, and another filter.

The key step of the invention is the process for analyzing a document which is the processes of
selecting links,
following links, and
matching links.

The method of selecting links may be simple and exhaustive or more narrow and efficient. Any or all of the following steps which illustrate but do not limit the invention may be used to select one or more links for analysis:
any uri embedded in a document,
a uri of a certain top level domain,
a uri not of a certain top level domain,
a uri containing a reference to a website,
a uri matching a category of a database,
a uri not matching a category of a database, and
a uri matching a regular expression in a database,
wherein a uri is a uniform resource identifier.

The present invention is distinguished from conventional content filtering by the process of following a link. Following may need to be repeated through a series of intermediate websites to obtain the target website. At each redirection following a link comprises:
requesting a resource by using the protocol and hierarchical path of a uri as a user would by clicking or as a browser would in displaying a hypertext document;
receiving at least one of codes, scripts, content, and redirection instructions from the server; and
analyzing at least one of codes, scripts, content, and redirection instructions for additional uri's.

In some cases, simply clicking on a link may imply purchasing, voting, unsubscribing, buying, or ordering. To prevent inadvertent signalling of an intention, the method of following a link may further comprise the step of neutering text strings appended to the end of a uri which relate to an individual email recipient before requesting the resource. In other words, if some data is transmitted with a query string we replace it with text that will be ineffective or anonymous.

Matching links is a process that may apply to a document which is a webpage, an email, or a redirection instruction. The present invention may use a database with one, two, three or more categories. In an embodiment matching links comprises the steps of:
extracting a domain name or website from a uri received with a redirection instruction, and
matching the domain name or website with one of a first category of websites in a database 541.

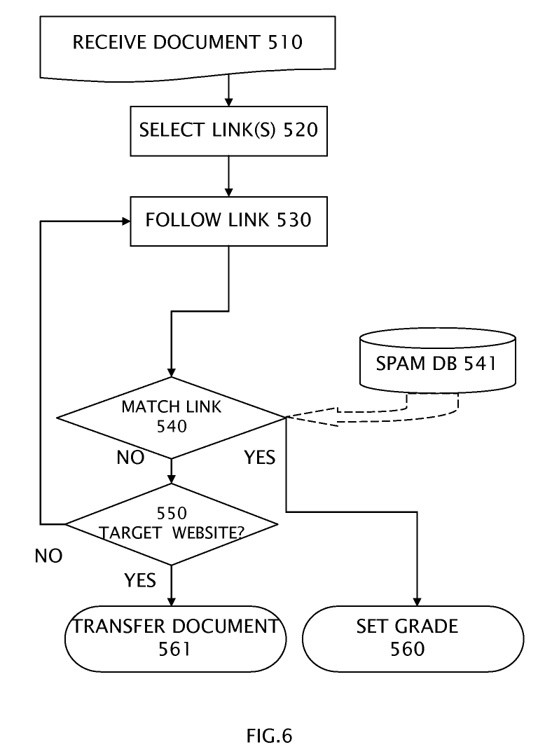

Referring now to FIG. 6, the simplest database is used which has a first category of websites wherein said first category of websites are herein defined as spam websites 541 whereby messages are stored for display to recipients of unsolicited bulk email commonly referred to as spam.

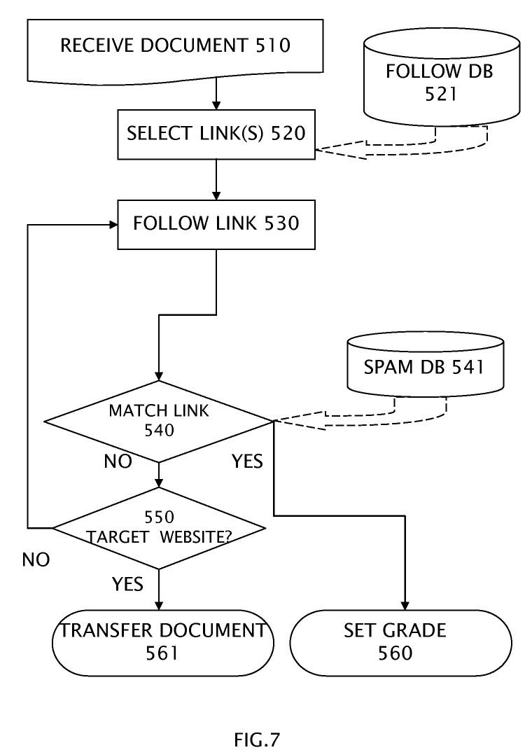

Referring now to FIG. 7 a second and more optimized embodiment for matching links illustrated in FIG. 7 further comprises matching the domain name with one of a second category of websites in a database. The second embodiment is supported by a database which adds a second category of websites wherein said second category are herein defined to be complimentary web hosts whereby anonymous users may freely publish content comprising at least one of scripts, hypertext documents, and redirection instructions. It is the observation of the inventors that most spammers make use of easy to setup complimentary web hosts. Email which does not contain links to these websites has lower chance of being spam.

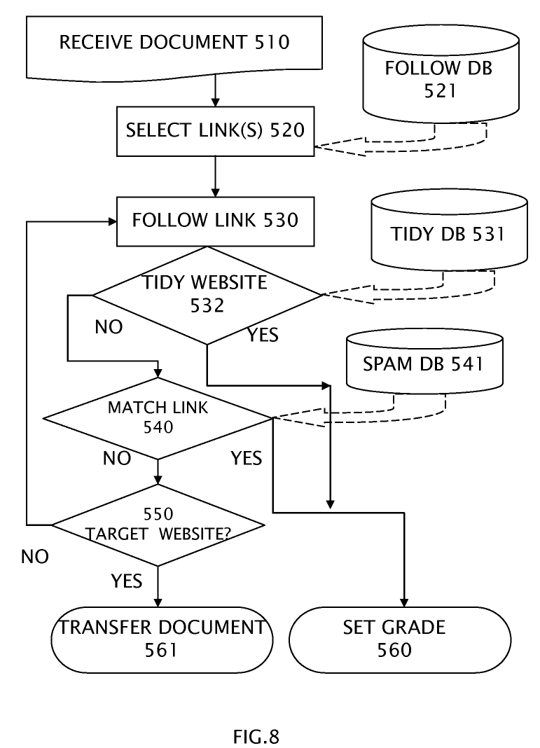

A third embodiment of matching links illustrated in FIG. 8 adds the optimization of matching the domain name and special code, special page or identifiable text with one of a third category of websites in a database. The third embodiment is supported by a database which adds a third category of websites wherein said third category are herein defined to be tidied websites and special codes, special pages, and identifiable text whereby a tidied website manager indicates that requested content has been purposefully removed.

The present invention is distinguished by following redirections from at least one first uri to at least one second uri and comparing the received website uri's with a database of categorized websites. In order to fully disclose enablement of the invention we provide one method of creating a database of categorized websites. This or some other technique can be used to create a database that the present invention accesses. An equivalent database created by a different process is also suitable.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings.

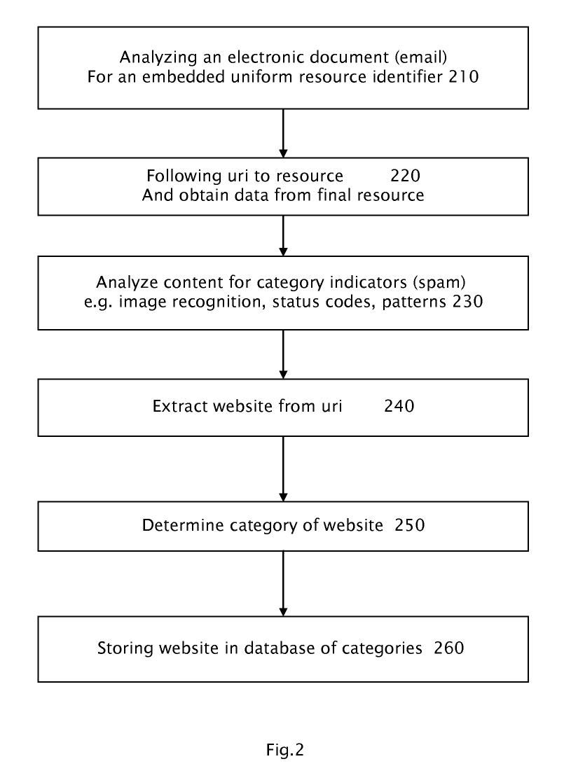

Referring now to FIG. 2 a flowchart illustrates a method for building a database of websites for multilevel content filtering of electronic documents. The method includes the following processes:
analyzing an electronic document for an embedded uniform resource identifier (uri) 210;
following uri to an Internet resource and obtaining data 220;
analyzing content for category indicators 230
extracting a website from a uri 240;
determining a category for the website 250; and
storing the website in a database for the category 260.

The first step is analyzing an electronic document 210 such an electronic mail document popularly called an email for an embedded uniform resource identifier such as http://www.uspto.gov which contains a protocol and a hierarchical part. By following the link as a browser or a user would to a destination, the method obtains an Internet resource 220 such as a webpage. The reply may include a status code and a redirection to one or more other webpages. Eventually a destination webpage is reached that provides content which may be analyzed by conventional methods 230 such as finding pattern expression of key words, image recognition, or manual means which leads to categorization of the website 250. The website is stored into a database along with its category 260. Determining a website from a uri may require pattern recognition of a website terminated with additional strings, a website with prefixes appended, or a website with obfuscation.

The preceding is one embodiment of building a reference database of spam or categorized websites. Other methods may achieve the same goal. Such a database may be used in accordance with the present invention independent of how it is generated or maintained.

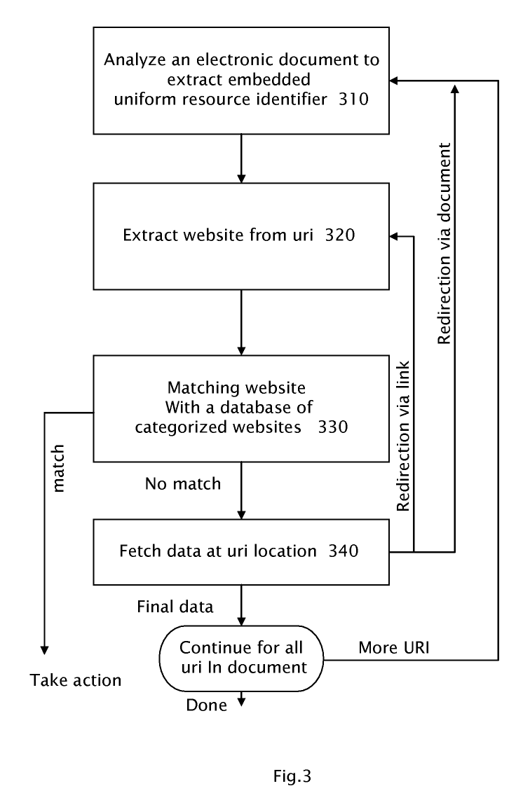

Referring now to FIG. 3 a flowchart illustrates a method of using a database of categorized websites to process documents, email, or web pages. The method comprises the step of analyzing an electronic document such as an email for a pattern expression for a uniform resource identifier (uri). Following the link as a browser or user would leads to one or more websites by redirection. By referencing a database, the email may be identified as spam or matching a category if there is a match of any of the traced websites with a categorized website in the database. An embodiment of the method which illustrates without limiting the invention is:
analyzing at least one electronic document to extract at least one embedded uniform resource identifier (uri) 310;
extracting a website from the uri 320;
operating on the electronic document if a website embedded in the document matches an entry in the database 330;
fetching status and content data from the uri location 340;
extracting another website if the status or content suggest redirection,
operating on the electronic document if the website alone or the website and the status code matches the database; and
continuing the processes above until there is a match or every website referenced directly or indirectly has been examined.

### Redirection

There are several techniques to implement a redirect known to those skilled in the art which include but are not limited to the following list:

1: HTTP status codes 3xx—In the HTTP computer protocol used by the World Wide Web, a “redirect” is a response with a status code beginning with 3 which directs a browser to go to another location. The HTTP standard defines several status codes for redirection:
300 multiple choices (e.g. offer different languages)
301 moved permanently
302 found (e.g. temporary redirect)
303 see other (e.g. for results of cgi-scripts)
307 temporary redirect
   All of these status codes require that the URL of the redirect target is given in the Location: header of the HTTP response. The 300 multiple choices will usually list all choices in the body of the message and show the default choice in the Location: header.

2: Using server side scripting for Redirection—Web page authors may not have sufficient permissions to produce the above status codes because the HTTP header is generated by the web server program and not read from the file for that URL. Even for CGI scripts, the web server usually generates the status code automatically and allows custom headers to be added by the script, such as printing “Location: ‘url’” header line. As a result, a web programmer who is using a scripting language may redirect the user's browser to another page.

3: Using .htaccess for Redirection—Certain server software implementations provide specific .htaccess file which can be used to change domain names.

4: Meta-refresh header—Some webserver software offer to refresh the displayed page after a certain amount of time. This method is often called meta refresh. It is possible to specify the URL of the new page, thus replacing one page by another page.

5: JavaScript redirects—JavaScript offers several ways to display a different page in the current browser window. There is no “standard” way of doing it.

6: Frame redirects—For a frame redirect, the browser displays the URL of the frame document and not the URL of the target page in the URL bar. This technique is commonly called cloaking.

7: URL redirection and obfuscation services—For a number of reasons, service providers offer URL redirection services sometimes for free or a fee. They exist to shorten long URLs which are hard to remember. They enable a URL owner to specify a second URL to which traffic will be forwarded. It enables “stealth” redirection where the destination URL is hidden. At little or no cost one website can be accessed through a large number of redirecting/obfuscating URLs.

As can be seen by the illustrations above, there are many ways to effect redirect. Others methods are known to those skilled in the art. The examples above are by illustration and not limiting the scope of the present invention which follows all redirection to a terminus at a server which may respond with at least one of a web page and an http status code.

Certain hosting service providers have policies to operate what the present application herein defines as tidied websites. When the hosting service provider determines that a website contains content that violates its service policy (such as containing redirects used in spam messages or other violations), it removes the offending content and notes the removal. This may be done by responding with a special status code, or the hosting service provider may redirect to a specific website. Or the hosting service provider may place identifiable text on the page located at the former redirect document.

Referring now to FIG. 8, the method further comprises the step of using a database of categorized tidied websites. As before, an electronic document is analyzed by finding an embedded uniform resource identifier (uri) containing a protocol and a domain. Tracing the uri obtains both domains and status codes at each level of redirection. A database containing both tidied websites and status codes is referenced 541. A match between the database and the websites and status codes obtained from tracing determines that the email is in a category such as spam.

In another embodiment, a match between a database of tidied websites and a list of certain pages determines that the email is in a category such as spam. In another embodiment, a match between a database of tidied websites and pattern matching identifiable text on the website determines that the email is in a category such as spam.

The present invention further comprises building a database of websites and further comprises building a database of websites which have credible status codes or trustworthy content identifying a category. In an embodiment the category is spam. Such a database may be distributed or accessed remotely.

An embodiment of the present invention is a computer readable medium adapted to control a computer system by encoded instructions which
analyze at least one electronic document to extract at least one embedded uniform resource identifier (uri) 310;
extract a website from the uri 320;
operate on the electronic document if a website embedded in the document matches with a database 330;
fetch status and content data from the uri location 340;
extract another website if the status or content suggest redirection,
operate on the electronic document if the website alone or the website and the status code matches with a database; and
continue the processes above until there is a match or every website referenced directly or indirectly has been examined.

An embodiment of the present invention comprises a first computing system managing and operating a database of categorized websites or a database of websites and status codes or content remote from but accessible to a second computing system filtering email and adapted to analyze the email using the method disclosed above.

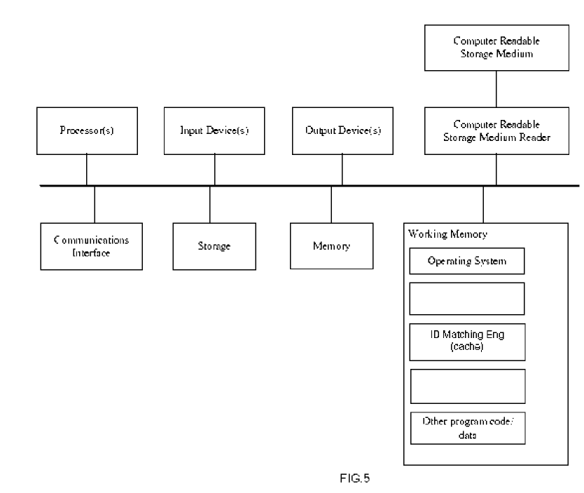

An embodiment of the present invention is at least one computing system according to FIG. 5 which applies the method of the invention tangibly encoded on computer readable media as a program product to email.

In the description herein for embodiments of the present invention, numerous specific details are provided, such as examples of components and/or methods, to provide a thorough understanding of embodiments of the present invention. One skilled in the relevant art will recognize, however, that an embodiment of the invention may be practiced without one or more of the specific details, or with other apparatus, systems, assemblies, methods, components, materials, parts, or the like or some combination. In other instances, well-known structures, materials or operations are not specifically shown or described in detail to avoid obscuring aspects of embodiments of the present invention.

It is appreciated by those skilled in the art that the present invention is tangibly embodied in a computing system embodiment. While other alternatives may be utilized or some combination, it will be presumed for clarity sake that components of systems herein are implemented in hardware, software or some combination by at least one computing systems consistent therewith, unless otherwise indicated explicitly or by context.

Computing system comprises components coupled via one or more communication channels (e.g. bus) including one or more general or special purpose processors, such as a Pentium®, Centrino®, Power PC®, digital signal processor (“DSP”), and so on. System components also include one or more input devices (such as a mouse, keyboard, microphone, pen, and so on), and one or more output devices, such as a suitable display, speakers, actuators, and so on, in accordance with a particular application.

A system also includes a computer readable storage media reader coupled to a computer readable storage medium, such as a storage/memory device or hard or removable storage/memory media; such devices or media are further indicated separately as storage and memory, which may include but are not limited to hard disk variants, floppy/compact disk variants, digital versatile disk (“DVD”) variants, smart cards, partially or fully hardened removable media, read only memory, random access memory, cache memory, and so on or some combination, in accordance with the requirements of a particular implementation. One or more suitable communication interfaces may also be included, such as a modem, DSL, infrared, RF or other suitable transceiver(s), and so on or some combination, for providing inter-device communication directly or via one or more suitable private or public networks or other components that may include but are not limited to those discussed.

Working memory of one or more devices may also include other program code or data (“information”), which may similarly be stored or loaded therein during use.

The particular OS may vary in accordance with a particular device, features or other aspects in accordance with a particular application, e.g., using Windows, WindowsCE, Mac, Linux, Unix, a proprietary OS, and so on or some combination and may be implemented as a real or virtual OS. Various programming languages or other tools may also be utilized, such as those compatible with C variants (e.g., C++, C#), the Java 2 Platform, Enterprise Edition (“J2EE”) or other programming languages. Such working memory components may, for example, include one or more of applications, add-ons, applets, servlets, custom software and so on for conducting but not limited to the examples discussed elsewhere herein. Other program code/data may, for example, include one or more of security, compression, synchronization, backup systems, groupware, networking, or browsing, client or other transmission mechanism code, and so on, including but not limited to those discussed elsewhere herein.

When implemented in software, one or more of components may be communicated transitionally or more persistently from local or remote storage to memory (SRAM, cache memory, and so on or some combination) for execution, or another suitable mechanism may be utilized, and one or more component portions may be implemented in compiled or interpretive form. Input, intermediate or resulting data or functional elements may further reside more transitionally or more persistently in a storage media, cache or other volatile or non-volatile memory, (e.g., storage device or memory ) in accordance with the requirements of a particular implementation.

An embodiment of the present invention is a computing system adapted to perform the methods of the invention according to a program product comprising executable instructions for the processor tangibly encoded in local or remote storage.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention.

### Conclusion

The present invention addresses the proliferation of spam email which has specious content which hides its intent. The present invention is distinguished from conventional email spam filters as illustrated by FIG. 6 by following one or more links through one or more levels of redirection to which a user or browser is redirected by a uri embedded within an email.

The invention may be tangibly embodied as an apparatus comprising a computing system and an article of manufacture comprising a program product. The invention may be tangibly embodied as a system comprising a remote computing system generating and operating a database of categorized websites and an email filtering apparatus comprising a computing system and an article of manufacture comprising a program product. The invention may be tangibly embodied as instructions encoded on a computer readable medium adapted to control a processor to analyze a document, find an embedded uri, and operate on the document if the uri matches a database of categorized websites.

What is claimed is:

1. A method, tangibly embodied as a program product encoded on computer readable media, for analyzing a document to determine if the document fits in a category, the method comprising the steps of:
extracting at least one uniform resource identifiers (uri) from a first document;
following a uri from a first document to a second document or a redirect;
extracting a uri from the redirect or the second document;
matching said extracted uri with a member of a database; and
determining said first document fits in the category associated with the uri found in said database.

2. The method of claim 1 wherein matching uses a regular expression or a partial match.

3. The method of claim 1 wherein matching uses algorithms to determine a website from a URI before matching to the database.

4. The method of claim 3 wherein determining a website comprises steps of pruning at least one of a prefix and a suffix appended to a website.

5. A method, tangibly embodied as a program product encoded on computer readable media, for analyzing a document to determine if the document fits in a category, the method comprising the steps of
extracting at least one link from a document;
following a link from the document to a second document or redirect;
extracting a text string from a redirect on the second document;
matching a text string extracted from a redirect with a member of a database; and
determining said first document fits in the category associated with the text string found in the database.

6. A method for analyzing a document comprising the steps of
selecting links,
following links,
matching links in a database, and
operating on a document wherein operating on a document comprises the process of causing the document to be blocked, deleted, diverted to a spam mailbox, marked with warning messages, tagged with a string, sterilized, quarantined, or modified, depending on the grade value; or notifying user of category.

7. The method of claim 6 further comprising
passing it on to one of an addressee, a user agent, a mail server, a gateway, and another filter, if an analysis determines that the document is not likely to be spam.

8. The method of claim 6 wherein selecting links comprises the process of pattern matching to identify at least one of the following:
any uri embedded in an email,
a uri of a certain top level domain,
a uri not of a certain top level domain,
a uri matching a first category of a database,
a uri matching a second category of a database, and
a uri matching a third category of a database; wherein a uri is a uniform resource identifier.

9. The method of claim 6 wherein following links comprises the steps of requesting a resource by one of the following using the protocol and hierarchical path of a uri as a user would by clicking and a browser would in displaying a document;
receiving at least one of codes, scripts, content, and redirection instructions from the server; and
analyzing at least one of codes, scripts, content, and redirection instructions for additional uri's, wherein a document is a electronic file containing at least one universal resource identifier (uri).

10. The method of claim 9 wherein following links further comprises the step of neutering text strings appended to the end of a uri which relate to an individual email recipient before requesting the resource.

11. A method for matching links comprising the steps of:
extracting a domain name from a uri received with a redirection instruction and matching the domain name with one of a first category of websites in a database.

12. The method of claim 11 where the database comprises a first category of websites wherein said first category of websites are herein defined as spam websites wherein spam websites are websites hosting messages stored for display to recipients of unsolicited bulk email commonly referred to as spam.

13. The method for matching links of claim 11 further comprising matching the domain name with one of a second category of websites in a database.

14. The method of claim 11 wherein the database further comprises a second category of “follow websites” wherein said second category are herein defined to be complimentary web hosts whereby anonymous users may freely publish content comprising at least one of scripts, hypertext documents, and redirection instructions.

15. The method of matching links of claim 11 further comprising matching the domain name and special code, special page or identifiable text with one of a third category of tidied websites in a database

16. The method of claim 11 wherein the database further comprises a third category of websites wherein said third category are herein defined to be tidied websites and special codes, special pages, and special text whereby a tidied website manager indicates that requested content has been purposefully removed.

17. A method for email client multilevel content filtering of electronic documents, comprising the following processes:
analyzing at least one electronic document to extract at least one embedded uniform resource identifier (uri);
extracting a website from the uri;
operating on the electronic document if at least one website embedded in the document matches with a database.

18. The method of claim 17 further comprising the steps of:
fetching status and content data from the uri location;
extracting another website if the status or content suggest redirection,
operating on the electronic document if the website alone or the website and the status code matches with a database; and
continuing the processes above until there is a match or every website referenced directly or indirectly has been examined.

19. A method comprising the steps following:
scanning an electronic document for at least one embedded uniform resource identifier; and
querying a database of categorized uniform resource identifiers to determine if the embedded uniform resource identifier matches.

20. The method of claim 19 further comprising the process of traversing at least one embedded uniform resource identifier wherein traversing comprises emulating a browser in requesting at least one resource through an internet protocol and receiving at least one response.

21. The method of claim 19 further comprising the process of traversing a plurality of embedded uniform resource identifiers wherein traversing comprises emulating a browser and requesting a first resource through an internet protocol and requesting a second resource based on a redirection received in response to the request for the first resource and repeating the process if necessary whereby a series of redirections is resolved to a target website.

22. The method of claim 21 further comprising querying the database to determine if a uniform resource identifier used in redirection has the characteristic of a categorized uniform resource identifier.

23. The method of claim 21 wherein redirection comprises a process selected from the following group:
receiving a 3xx http status code wherein x is a numeral;
receiving and resolving a refresh meta tag;
receiving and resolving an http refresh header;
receiving and resolving a Javascript redirect; and
receiving and resolving a frame redirect.

24. The method of claim 21 further comprising receiving an http error status code in response to traversing a uniform resource identifier wherein an http error status code comprises one of 4xx and 5xx wherein x is a numeral.

25. The method of claim 21 further comprising receiving at least one document and analyzing the document for at least one link found in a database of categorized websites.

26. The method of claim 25 wherein analyzing comprises scanning for a pattern expression which suggests navigating to a website and matching the website in a database of known spam uniform resource identifiers.

27. The method of claim 25 wherein analyzing comprises scanning for a pattern expression which suggests a Javascript redirection and matching the redirection in a database of known spam uniform resource identifiers.

28. The method of claim 25 wherein analyzing comprises scanning for a pattern expression which suggests an obfuscated Javascript.

29. The method of claim 25 wherein analyzing comprises scanning for manual instructions to navigate to a website in a database of known spam uri.

30. The method of claim 25 further comprising operating on the electronic mail document wherein operating is selected from the following group: editing the content of the document, blocking the document, inserting a tag into the document, responding to the sender of the document, setting a score, forwarding the document, calling a function with meta data extracted from the document, lowering the priority of the document, bouncing the document, and disconnecting from the source of the document.

31. An article of manufacture comprising computer readable media on which is encoded instructions adapted to control a processor in matching a pattern expression of categorized uniform resource identifiers.

32. A computing system for multilevel domain redirection analysis comprising a processor adapted to perform the methods following coupled to a storage in which is tangibly encoded computer readable instructions which adapt the processor to access a database of categorized websites and analyze an electronic document to extract an embedded uniform resource identifier;
extract a website from the uri;
match the website with a database of categorized websites;
fetch data at the uri location;
if there is redirection, extract another website, if there is a match, take action on the electronic document, and exhausting all the uri's embedded in a document.
